(19) United States
(12) Patent Application Publication
(10) Pub. No.: US 2026/0216542 A1
(43) Pub. Date: Jul. 30, 2026

(54) Systems and Methods for Wildfire Fighting/Abatement

(71) Applicant: John L. Rogitz, San Diego, CA (US)

(72) Inventor: John L. Rogitz, San Diego, CA (US)

(21) Appl. No.: 19/040,776

(22) Filed: Jan. 29, 2025

(51) Int. Cl. A62C 3/02; A62C 37/11

(52) U.S. Cl. CPC A62C 3/0235; A62C 3/0214; A62C 3/0292; A62C 37/11

(57) ABSTRACT

Systems and methods include one or more drones with water drop capability and/or one or more outside water nozzles oriented upward to spray water on an upward trajectory. The drones may include water tanks, and the drones and/or outside water nozzles are computer-controlled to automatically douse fire on the buildings and other areas. Or, the drones and/or outside water nozzles can be computer-controlled to douse fire on the buildings and other areas only in response to signals from firemen controllers.

### FIELD

The present application relates generally to systems and methods for fighting and/or abating wildfires.

### BACKGROUND

Loss of life is a tragic product of most large wildfires. Moreover, wildfires cause ever-increasing economic loss as homes are increasingly built in fire-prone areas and have ever-increasing dollar values.

### SUMMARY

Accordingly, a system includes plural flyable drones each having at least one tank, and at least one control system to control the drones to drop water and/or fire retardant chemical from the respective tanks onto a wildfire.

In some embodiments at least some of the drones include least one respective infrared (IR) sensor and at least one respective processor system configured to fly the respective drones over the wildfire responsive to signals from the respective IR sensors, with the respective processors being part of the control system.

In example embodiments at least some of the drones can include at least one respective communication interface to receive signals from at least one source of fire reporting and at least one respective processor system configured to fly the respective drones over the wildfires responsive to signals from the respective communication interfaces, with the respective processors being part of the control system. In non-limiting examples the source of fire reporting includes a satellite and/or a terrestrial transmitter. The wildfire can be in a town.

In example embodiments at least one sensor and at least one respective processor system are provided, and the processor system is configured to fly the respective drones over the wildfire responsive to signals from the sensor. The sensor can include one or more of a smoke sensor, heat sensor, and camera.

In another aspect, a system includes plural water nozzles located in an area having plural burnable buildings. The nozzles are disposed outside of the buildings. At least some water nozzles are controlled by respective controllers to spray water onto external surfaces of the buildings responsive to a control signal.

In some examples of this aspect, at least one heat sensor and/or smoke sensor and/or camera is configured to generate the control signal and at least one signal path is between the heat sensor and at least some of the water nozzles.

If desired, at least some of the water nozzles can have respective internal valves controllable by the respective controllers. At least some of the nozzles may be oriented to spray water at an angle above the horizontal. A water reservoir such as a lake can be connected to the nozzles. A control element can be manipulable to generate the control signal and a signal path is between the control element and at least some of the water nozzles.

In another aspect, a system includes a drone associated with a dwelling and having an onboard water tank. A signal interface is on the drone to receive a liftoff signal, and a controller is in the drone to fly the drone over the dwelling responsive to the liftoff signal and drop water onto the dwelling from the tank.

In another aspect, a system includes plural water nozzles located adjacent a single building and being disposed outside of the building. At least some water nozzles are controllable by respective controllers to spray water onto external surfaces of the building responsive to a control signal, which includes output from a machine learning (ML) model receiving input from at least one sensor.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 illustrates an example drone consistent with present principles;

FIG. 3 illustrates an example drone-based system consistent with FIG. 2 to protect a structure from wildfire;

FIGS. 4-6 illustrate operations of the drone shown in FIGS. 2 and 3;

FIG. 7 illustrates an example water jet-based system to protect a structure from wildfire;

FIG. 8 illustrates example logic in example flow chart format for drone operation;

FIG. 9 illustrates further example logic in example flow chart format for drone operation;

FIG. 10 illustrates still further example logic in example flow chart format for drone operation;

FIG. 11 illustrates example logic in example flow chart format for water nozzle operation;

FIG. 12 illustrates further example logic in example flow chart format for water nozzle operation;

FIG. 13 illustrates example logic for training a machine learning (ML) model to recognize fire situations from camera signals;

FIG. 14 illustrates example logic for training a machine learning (ML) model to recognize fire situations from smoke sensor signals;

FIG. 15 illustrates example logic for training a machine learning (ML) model to recognize fire situations from heat sensor signals;

FIG. 16 illustrates an example drone-based system and an example water jet/nozzle system to protect an area such as a neighborhood or town from wildfire;

FIG. 17 illustrates a drone swarm over an area consistent with FIG. 16;

FIG. 18 illustrates water jets/nozzles in an area consistent with FIG. 16;

FIG. 19 illustrates example logic in example flow chart format for controlling the drone swarm in FIG. 16;

FIG. 20 illustrates further example logic in example flow chart format for controlling the drone swarm in FIG. 16;

FIG. 21 illustrates still further example logic in example flow chart format for controlling the drone swarm in FIG. 16;

FIG. 22 illustrates example logic in example flow chart format for controlling the water jets/nozzles in FIG. 16; and

FIG. 23 illustrates further example logic in example flow chart format for controlling the water jets/nozzles in FIG. 16.

### DETAILED DESCRIPTION

A system herein may include server and client components which may be connected over a network such that data may be exchanged between the client and server components. The client components may include one or more devices with processor systems including fixed weather sensing stations, weather-reporting and weather-sensing satellites and airborne craft, drone aircraft, fixed land appliances such as water stream sources such as valves, sprinklers, and fire hydrants alone or in combination, extended reality (XR) headsets such as virtual reality (VR) headsets, augmented reality (AR) headsets, portable drone controllers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google. These operating environments may be used to execute one or more browsing programs, such as a browser made by Microsoft or Google or Mozilla or other browser program that can access websites hosted by the Internet servers discussed herein.

Servers and/or gateways may be used that may include one or more processors executing instructions that configure the servers to receive and transmit data over a network such as the Internet. Or a client and server can be connected over a local intranet or a virtual private network.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single-or multi-chip processor that can execute logic by means of various lines such as address lines, data lines, and control lines and registers and shift registers. A processor including a digital signal processor (DSP) may be an embodiment of circuitry. A processor system may include one or more processors.

Components included in one embodiment can be used in other embodiments in any appropriate combination. For example, any of the various components described herein and/or depicted in the Figures may be combined, interchanged, or excluded from other embodiments. “A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

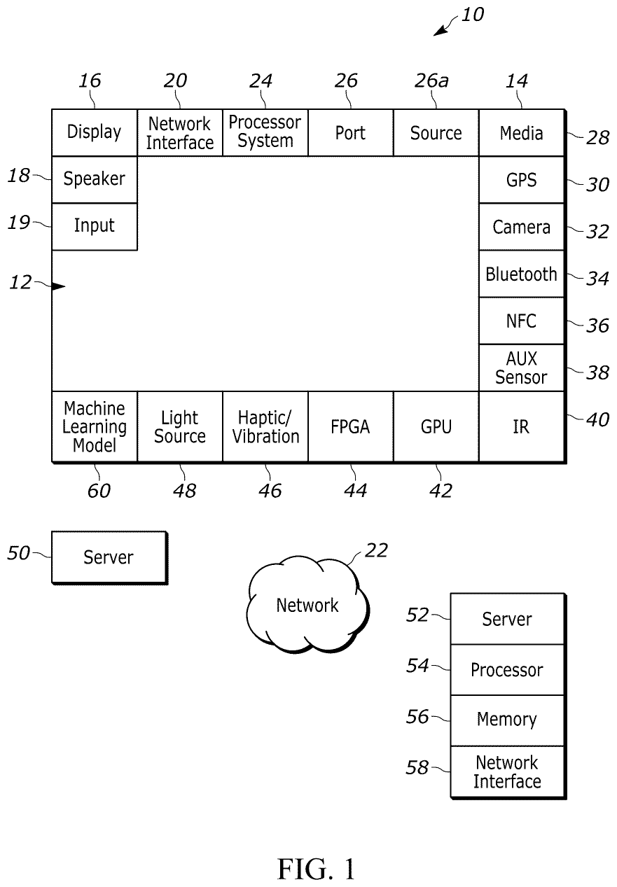

FIG. 1 shows relevant computer elements an example computerized component system 10, which may include one or more of the example devices mentioned herein in accordance with present principles. The first of the example devices included in the system 10 is a device 12 with chassis 14. The device 12 is configured to undertake present principles (e.g., communicate with other devices to undertake present principles, execute the logic described herein, and perform any other functions and/or operations described herein).

Accordingly, to undertake such principles the device 12 can include some, or all of the components shown. For example, the device 12 can include one or more touch-enabled displays 16 that may be implemented by a liquid crystal display (LCD) and/or light emitting diode (LED) array. The display 16 may be a high definition or ultra-high definition “4K” or higher flat screen. The touch-enabled display(s) 16 may include, for example, a capacitive or resistive touch sensing layer with a grid of electrodes for touch sensing consistent with present principles.

The device 12 may also include one or more speakers 18 for outputting audio in accordance with present principles, and at least one additional input device 19 such as an audio receiver/microphone for entering audible commands to the device 12 to control the device 12. The example device 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the device 12 to undertake present principles, including the other elements of the device 12 described herein such as controlling the display 16 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the device 12 may also include one or more input and/or output ports 26 such as a high-definition multimedia interface (HDMI) port or a universal serial bus (USB) port to physically connect to another device and/or a headphone port to connect headphones to the device 12 for presentation of audio from the device 12 to a user through the headphones. For example, the input port 26 may be connected via wire or wirelessly to a cable or satellite source 26a of audio video content. Thus, the source 26a may be a separate or integrated set top box, or a satellite receiver.

The device 12 may further include one or more computer memories/computer-readable storage media 28 such as disk-based or solid-state storage that are not transitory signals, in some cases embodied in the chassis 14 of the device 12 as standalone devices or as either internal or external to the chassis of the device. Also, in some embodiments, the device 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the device 12 is disposed in conjunction with the processor 24.

Continuing the description of the device 12, in some embodiments the device 12 may include one or more cameras 32 that may be a thermal imaging camera, a digital camera such as a webcam, an IR sensor, an event-based sensor, and/or a camera integrated into the device 12 and controllable by the processor 24 to gather pictures/images and/or video in accordance with present principles. Also included on the device 12 may be a Bluetooth® transceiver 34 and other Near Field Communication (NFC) element 36 for communication with other devices using Bluetooth and/or NFC technology, respectively. An example NFC element can be a radio frequency identification (RFID) element. Further still, the device 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command), a smoke sensor. The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the device 12 in three dimension or by an event-based sensor such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

Other auxiliary sensor types that can be included at element 38 can include wind speed and direction sensors and humidity sensors.

In addition to the foregoing, it is noted that the device 12 may also include an infrared (IR) transmitter and/or IR receiver and/or IR transceiver 40 such as an IR data association (IRDA) device. A battery (not shown) may be provided for powering the device 12, as may be a kinetic energy harvester that may turn kinetic energy into power to charge the battery and/or power the device 12. A graphics processing unit (GPU) 42 and field programmable gated array 44 also may be included. One or more haptics/vibration generators 46 may be provided for generating tactile signals that can be sensed by a person holding or in contact with the device. The haptics generators 46 may thus vibrate all or part of the device 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source 48 such as a projector such as an infrared (IR) projector also may be included.

In addition to the device 12, the system 10 may include one or more other device types 50. In the example shown, only two CE devices are shown, it being understood that fewer or greater devices may be used. A device herein may implement some or all of the components shown for the device 12. Any of the components shown in the following figures may incorporate some or all of the components shown in the case of the device 12.

The system 10 further may include one or more servers 52 with one or more server processor systems 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments.

The components shown in the following figures may include some or all components shown in herein. Any user interfaces (UI) described herein may be consolidated and/or expanded, and UI elements may be mixed and matched between UIs.

Present principles may employ various machine learning models such as the ML model 60 shown in FIG. 1 and executable by any of the processor systems herein. ML models include deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative models such as large language models (LLM) such as generative pre-trained transformers (GPTT) also may be used. Support vector machines (SVM) and Bayesian networks also may be considered to be examples of machine learning models. In addition to the types of networks set forth above, models herein may be implemented by classifiers. As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that are configured and weighted to make inferences about an appropriate output.

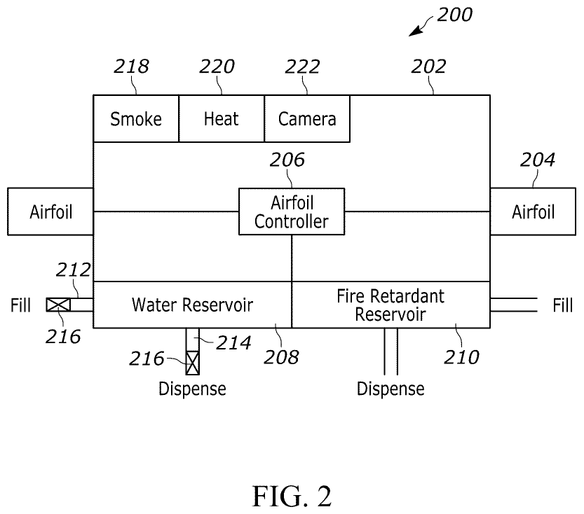

FIG. 2 illustrates an example firefighting drone 200 with an airframe 202 and one or more airfoils 204 moved as appropriate for flight control by an airfoil controller 206, which can include mechanical linkages and/or computer processing components such as any of the components shown in the device 12 of FIG. 1. The drone 200 may be embodied as a fixed win aircraft or helicopter, for example.

As shown, the drone 200 may include one or more water reservoirs 208 and/or one or more chemical-based fire retardant reservoirs 210. Each reservoir may have a respective fill port 212 for filling the reservoir and a dispensing port 214 for dispensing the contents of the respective reservoir onto a location such as a burning structure or structure not yet burned but at risk of an approaching fire. Electrically-controlled valves 216 such as solenoid valve typically are provided in the ports 212, 214 to open and close the ports. Note that solenoid valves may be provided in other components herein to selectively open and close fire fighting substance pathways.

In some embodiments, the drone 200 may include, in addition to one or more of the sensor components and communication components shown in FIG. 1 in the case of the device 12, one or more of a smoke sensor 218, a heat sensor 220, and an infrared or red-green-blue (RGB) camera 222, for purposes to be shortly disclosed.

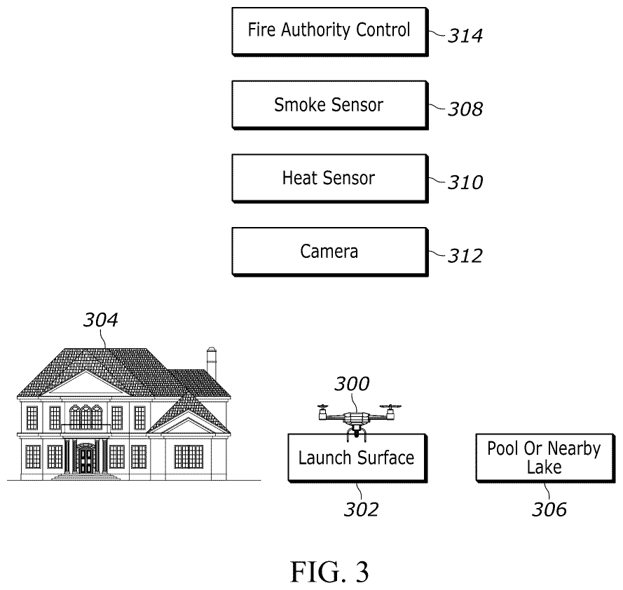

FIG. 3 illustrates a first example embodiment in which a drone 300, which may be embodied by any of the drones described herein such as the drone 200 in FIG. 2, is disposed on a launch surface 302 prior to a fire. The drone 300 is assigned to or correlated with a specified structure 304 such as a dwelling, perhaps through private or public contract. Thus, the owner of the dwelling 304 is assured that a firefighting drone is dedicated to protecting the dwelling in the event of a fire.

The dwelling may be on property that includes or is nearby a lake or pool 306 or indeed a salt water body or public water main or underground water tank. The launch surface 302 may be on the dwelling's property or may be remote from the property, and in any case the drone 300 can be pre-filled with water and/or fire retardant chemical or, upon approach of a fire, it can lift off and obtain water from the pool or lake 306.

Both the sensing of a nearby fire approaching the dwelling 304 and/or control of the flight and firefighting operation of the drone 300 may be afforded using one or more sensors such as a smoke sensor 308, heat sensor 310, and IR and/or RGB camera 312. Wind sensors also may be provided. Such sensors may be onboard the drone as shown in FIG. 2 and/or may be remote from the drone and can communicate with the drone via a wireless network and/or via a fire authority control computer system 314. The fire authority system 314 may be a public fire authority or a private authority such as a homeowner association system.

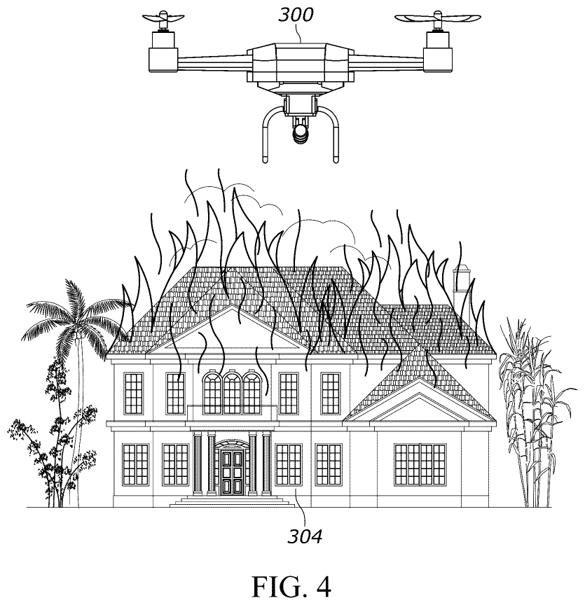

As illustrated in FIG. 4, either during or prior to a wildfire reaching the dwelling 304, the drone 300 is programmed and/or controlled to fly and drop water and/or fire retardant onto the dwelling and the vicinity thereof.

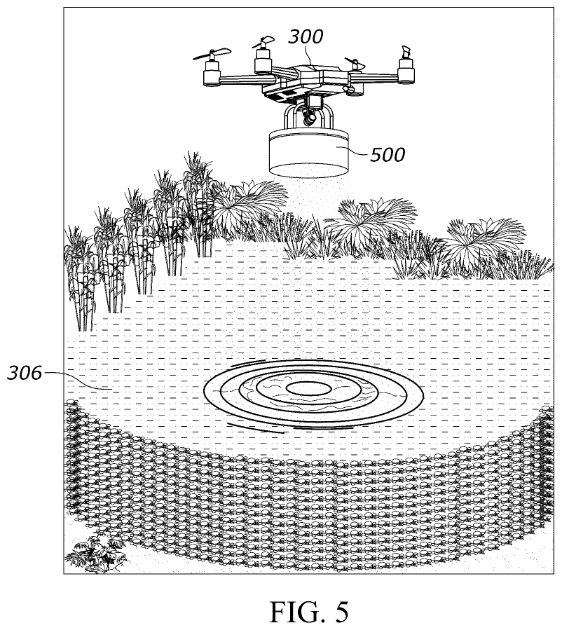

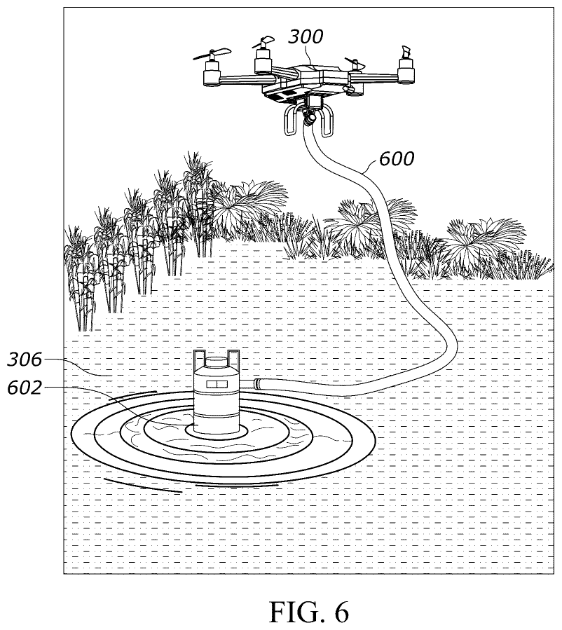

FIG. 5 illustrates that the drone 300 may acquire water from the pool or lake 306 using a bucket 500, which can function as a water reservoir that hangs below the airframe of the drone. In contrast, FIG. 6 shows that the drone 300 can draw water from the lake or pool 306 into a reservoir internal to the airframe of the drone through a hose 600 that can terminate in a water filter 602.

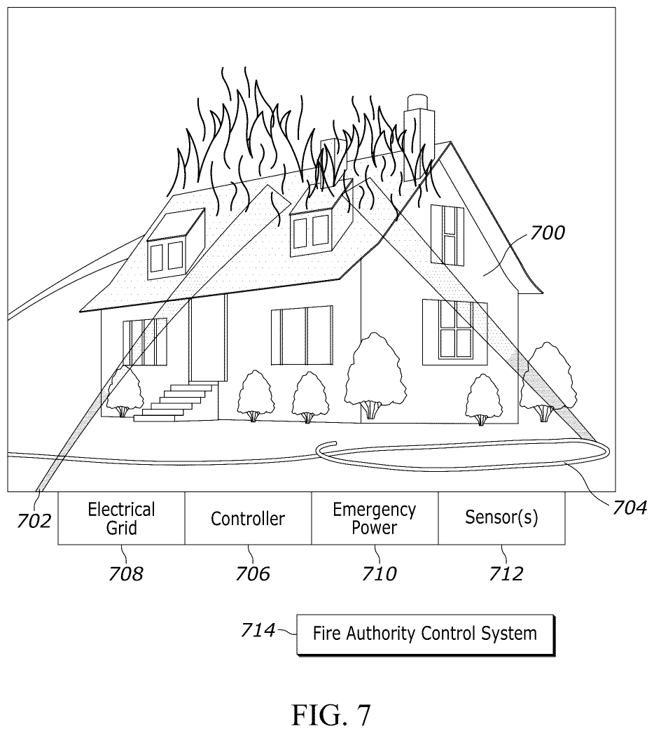

FIG. 7 illustrates an additional or alternate technique to protect a structure 700 from wildfires. Plural electrically-controlled external water jets 702 are mounted on the ground near the structure 700 and are oriented to project water upwardly (in an initial projection angle above the horizontal) onto the structure 700 to wet its roof prior to catching fire and/or douse a fire on the roof. The jets 702 may be connected to the public water main and/or to a nearby water source such as a tank or pool or lake via above-ground or underground emergency conduits 704.

Each jet can include a respective electrically-controlled valve that is controlled by a processor-implemented controller 706 energized from the public electrical grid 708 and/or from an emergency power source 710 such as a home diesel generator or battery bank. One or more heat and/or smoke sensors and/or cameras 712 and/or wind sensors may provide input to the controller 706 to activate the nozzles to douse the structure. In addition or alternatively, the jets may be activated by signals from a fire authority control system 714 sent to the controller 706 to activate the jets.

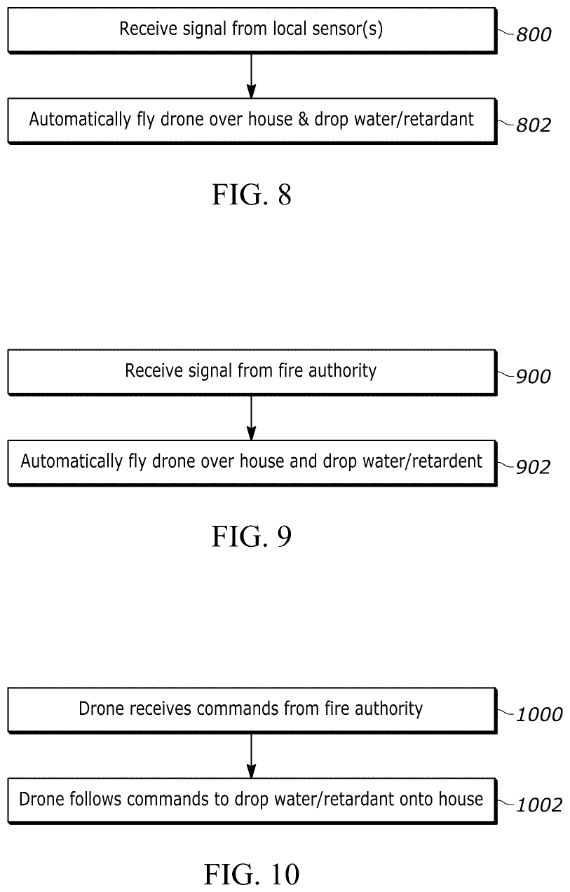

The following flow charts expand on logic executed by the appropriate controllers herein attendant to the systems and techniques of FIGS. 2-7. Commencing at state 800 in FIG. 8, one or more sensors on the drone 300 in FIG. 3 or remote from the drone but communicating therewith generate signals representing possible fire. In response, at state 802 the drone 300 can fly over the location of the pre-designated structure 304 (using, e.g., a GPS sensor such as the sensor shown in FIG. 1 and after filling its reservoir with water from the lake or pool if need be) to drop water and/or fire retardant onto the structure. In this technique, the drone is completely autonomous, i.e., no human operating a remote control flies the drone or indeed causes the drone to take off. Instead, the controller onboard the drone executes logic to automatically fly the drone to the designated location and drop water/retardant.

For instance, the drone may automatically take off and fly to douse a structure based on smoke being sensed by a smote sensor and/or based on signals from a wind and/or humidity sensor indicating windy, dry conditions. The drone may be enabled to do this in advance by its own internal programming. Or, the drone may be enabled for automatic operation by an enable signal from the fire authority system 314 such that the drone is enabled for automatic operation based on sensor signals only upon enablement by the fire authority system 314.

On the other hand, commencing at state 900 in FIG. 9, a signal is received by the drone from the fire authority system 314 to activate. In response, at state 902 the drone 300 can fly over the location of the pre-designated structure 304 (using, e.g., a GPS sensor such as the sensor shown in FIG. 1 and after filling its reservoir with water from the lake or pool if need be) to drop water and/or fire retardant onto the structure. In this technique, the drone may be completely autonomous once the fire authority system 314 launches it, i.e., no human operating a remote control may fly the drone.

In contrast, commencing at state 1000 in FIG. 10, a signal is received by the drone from the fire authority system 314 to activate. In response, at state 1002 the drone 300 is flown by a person operating a remote control distanced from the drone over the location of the pre-designated structure 304 to drop water and/or fire retardant onto the structure. In this technique, the drone is not completely autonomous because a human typically in a building and looking at a monitor showing a video feed captured by the camera on the drone uses a remote control to fly the drone.

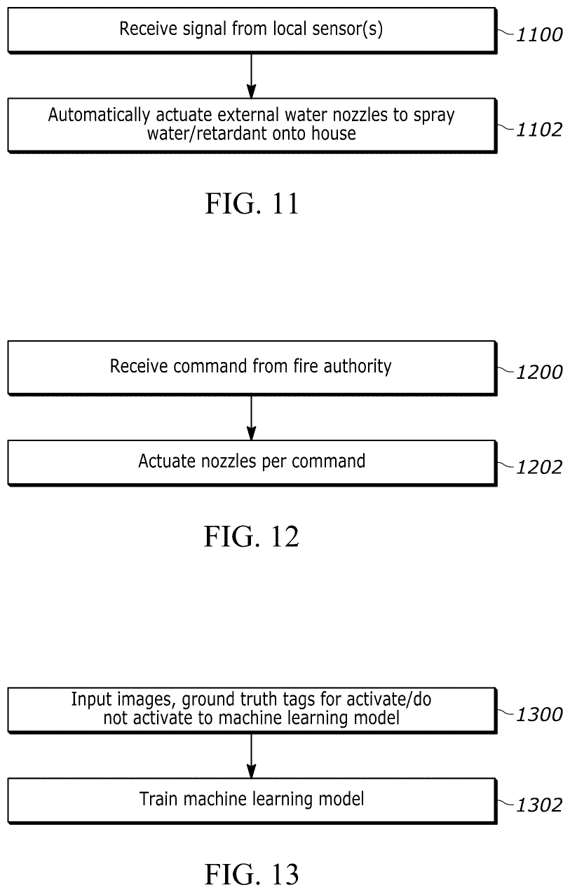

FIGS. 11 and 12 relate to techniques associated with the water jet system of FIG. 7. Commencing at state 1100 in FIG. 11, a signal is received from one or more sensors 712 in FIG. 7 or remote from the structure 700 but communicating therewith and representing possible fire. In response, at state 1102 the water jets 702 are automatically actuated by the local controller 706 without command from the fire authority.

In FIG. 12 on the other hand, at state 1200 a signal is received by the local controller 706 from the fire authority system 714 to activate the water jets 702. In response, at state 1202 the water jets 702 are actuated by the local controller 706.

FIG. 13 illustrates machine learning techniques for training a ML model to be executed by a processor system onboard a drone or by a water jet controller to automatically recognize and alleviate a fire. The ML model may be executed by any processor system herein including single-structure applications and areal applications.

Commencing at state 1300, a training set of camera images of a fire along with corresponding ground truth tags indicating that the respective image indicates drone or water jet activation or does not indicate such activation are input to a ML model, such as the ML model 60 shown in FIG. 1. The model is trained on the training set at state 1302. Subsequently, a drone or water jet controller can execute the ML model on images received from the corresponding cameras to determine whether a fire condition exists and if so to identify, from real time images, the fire to be battled.

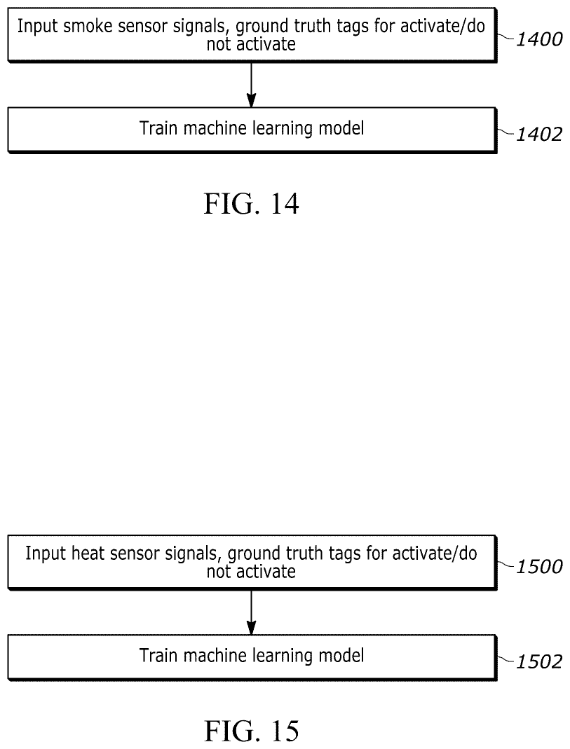

FIG. 14 illustrates machine learning techniques for training a ML model to be executed by a processor system onboard a drone or by a water jet controller to automatically recognize and alleviate a fire. Commencing at state 1400, a training set of smoke sensor signals along with corresponding ground truth tags indicating that the respective signal indicates drone or water jet activation or does not indicate such activation are input to a ML model, such as the ML model 60 shown in FIG. 1. The model is trained on the training set at state 1402. Subsequently, a drone or water jet controller can execute the ML model on signals received from the corresponding smoke sensors to determine whether a fire condition exists and if so to identify, from real time sensor signals, the fire to be battled.

FIG. 15 illustrates machine learning techniques for training a ML model to be executed by a processor system onboard a drone or by a water jet controller to automatically recognize and alleviate a fire. Commencing at state 1500, a training set of heat sensor signals along with corresponding ground truth tags indicating that the respective signal indicates drone or water jet activation or does not indicate such activation are input to a ML model, such as the ML model 60 shown in FIG. 1. The model is trained on the training set at state 1502. Subsequently, a drone or water jet controller can execute the ML model on signals received from the corresponding heat sensors to determine whether a fire condition exists and if so to identify, from real time sensor signals, the fire to be battled.

Note that the ML model also may be trained on a combination of signals including images, heat sensor signals, humidity signals, wind sensor signals, and smoke signals.

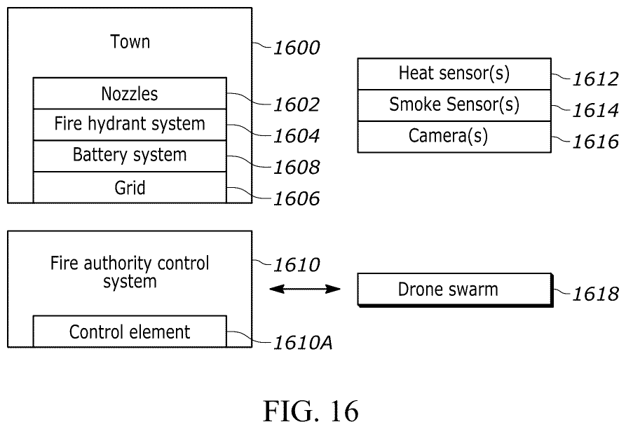

While FIGS. 1-7 relate to single structure wildfire protection, the following figures relate to areal wildfire protection, e.g., for a neighborhood or town 1600 as shown in FIG. 16.

As discussed further herein, plural water jets or nozzles 1602 are distributed around the town, typically round-mounted. The nozzles 1602 may be connected to a fire hydrant system 1604 and may be electrically actuated using electricity from the public electrical grid 1606 and/or an emergency power supply 1608 such as a diesel generator and/or battery system. At least some of the nozzles may be oriented to spray water at an angle above the horizontal.

The nozzles 1602 may be actuated by commands from a fire authority control system 1610, which may be satellite-borne and/or ma include a terrestrial transmitter, like the other fire authority systems herein. The fire authority control system 1610 may include one or more computers with input devices having control elements 1610A such as computer keys to generate control signals to control nozzles and drones described herein. In addition or alternatively, the nozzles 1602 may be actuated based on signals from one or more sensors such as a heat sensor 1612, smoke sensor 1614, humidity sensor, wind sensor, and camera(s) 1616. It is to be understood that the nozzles can have internal actuation valves activated by electricity, such as the valves 216 shown in FIG. 2.

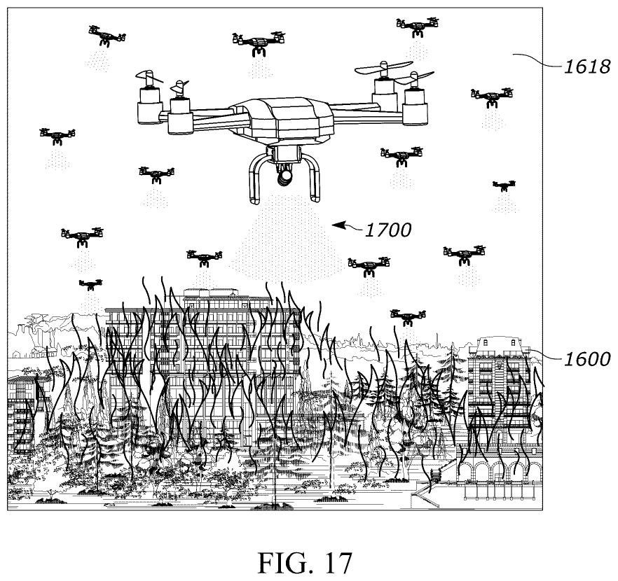

In addition to or in lieu of the nozzles 1602, a swarm of water-carrying and/or chemical fire retardant-carrying flyable drones 1618 may be availed by the town for wildfire fighting purposes as illustrated in FIG. 17 by dropping water and/or fire retardant chemicals 1700 on the town.

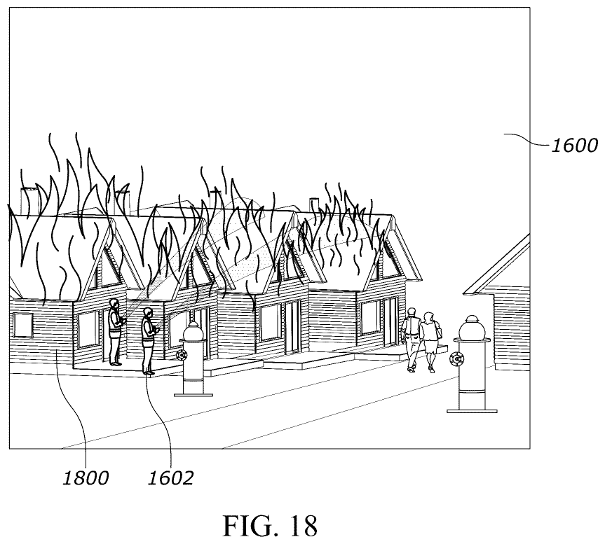

FIG. 18 illustrates the nozzles 1602 spraying water and fire retardant onto roofs of buildings 1800 in the town 1600.

The following flow charts relate to logic for areal wildfire protection consistent with FIGS. 16-18.

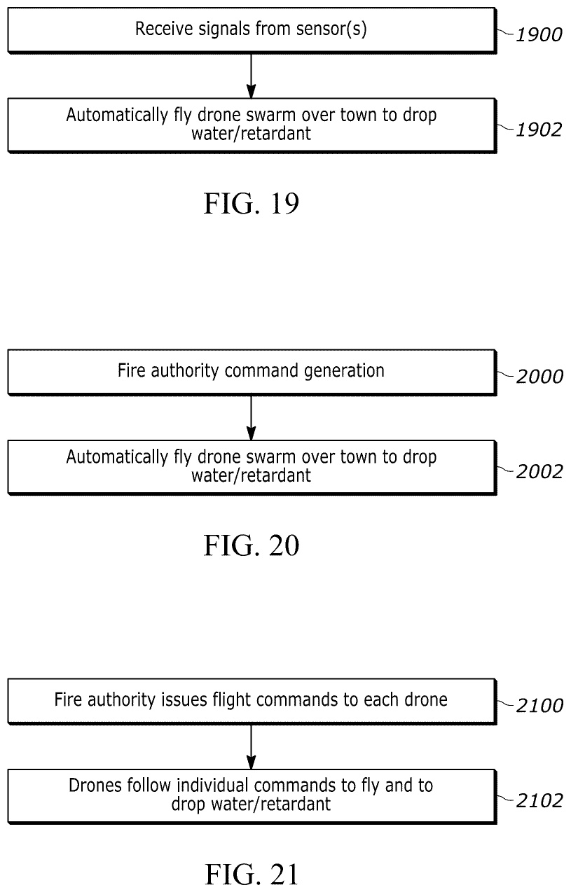

Commencing at state 1900 in FIG. 19, one or more sensors on one or more of the drones in the drone swarm 1618 or remote from the drone but communicating therewith generate signals representing possible fire or fire conditions (low humidity, high winds as indicated by respective humidity and wind sensors). In response, at state 1902 the drones in the swarm 1618 can fly over the town 1600 (using, e.g., a GPS sensor such as the sensor shown in FIG. 1 and after filling reservoirs with water from lakes or pools if need be) to drop water and/or fire retardant onto the town 1600. In this technique, the drones are completely autonomous, i.e., no human operating a remote control flies the drone. Instead, the controllers onboard the drones execute logic to automatically fly the drones to drop water/retardant onto locations identified from images or sensors by ML models trained consistent with principles herein. The drones 1618, like all other systems herein, may be programmed or used to prospectively douse structures before a fire arrives and/or douse burning structures and areas. Note that collision avoidance may be effected by assigning subsets of drones to respective sub-regions of the area or town 1600 and then assigning drones within a single sub-region different altitudes. Water drops can be calculated based on height above the ground as indicated by an altimeter and wind speed and direction as indicated by a wind sensor on the drone.

Furthermore, the drones may take flight in waves according to a predetermined schedule, so that one subset of drones douses a region considered to be vulnerable and later a second subset of drones can douse that dame region. A vulnerable region may be one with many or sensitive structures or a region in an expected geographic wind funnel at which a fire might be more likely to start than in other areas.

On the other hand, commencing at state 2000 in FIG. 20, a signal is received by the drone swarm 1618 from the fire authority system 1610 to activate. In response, at state 2002 the drones can fly over the town 1600 (using, e.g., a GPS sensor such as the sensor shown in FIG. 1 and after filling reservoirs with water if need be) to drop water and/or fire retardant onto the town. In this technique, the drones may be completely autonomous, i.e., no human operating a remote control may fly the drones once the command to take off is received.

In contrast, commencing at state 2100 in FIG. 21, a signal is received by the drone swarm 1618 from the fire authority system 1610 to activate. In response, at state 2102 the drone swarm is flown by one or more people operating one or more remote controls distanced from the drone swarm over the town to drop water and/or fire retardant onto the town. In this technique, the drones are not completely autonomous because humans typically in a building and looking at monitors showing video feeds captured by cameras on the drones use remote controls to fly the respective drones.

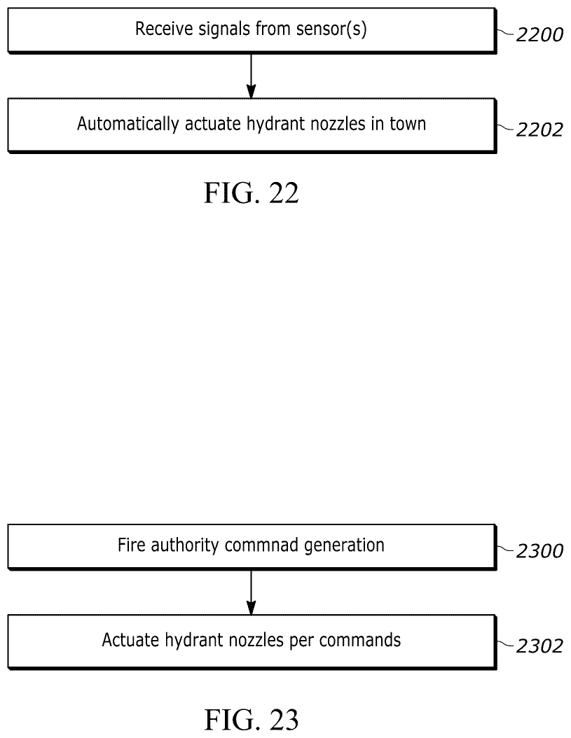

FIGS. 22 and 23 relate to techniques associated with the nozzles 1602. Commencing at state 2200 in FIG. 22, a signal is received from one or more sensors 1612-1616 in FIG. 16. In response, at state 2202 the nozzles 1602 are automatically actuated by the local controller without command from the fire authority.

In FIG. 23 on the other hand, at state 2300 a signal is received by the local controller from the fire authority system 1610 to activate the nozzles or water jets 1602. In response, at state 2302 the nozzles/water jets 1602 are actuated.

While the particular embodiments are herein shown and described in detail, it is to be understood that the subject matter which is encompassed by the present invention is limited only by the claims.

1-9. (canceled)

10. A system comprising:
plural ground-mounted water nozzles located in an area comprising plural burnable buildings and being disposed outside of the buildings;
at least some water nozzles being controlled by respective controllers to spray water onto external surfaces of the buildings responsive to a control signal.

11. The system of claim 10, comprising at least one heat sensor configured to generate the control signal and at least one signal path between the heat sensor and at least some of the water nozzles.

12. The system of claim 10, comprising at least one smoke sensor configured to generate the control signal and at least one signal path between the smoke sensor and at least some of the water nozzles.

13. The system of claim 10, comprising at least one camera configured to generate the control signal and at least one signal path between the camera and at least some of the water nozzles.

14. The system of claim 10, wherein at least some of the water nozzles comprise respective internal valves controllable by the respective controllers.

15. The system of claim 10, wherein at least some of the nozzles are oriented to spray water at an angle above the horizontal.

16. The system of claim 10, comprising at least one water reservoir connected to the nozzles.

17. The system of claim 16, wherein the reservoir comprises at least one lake.

18. The system of claim 10, comprising at least one control element manipulable to generate the control signal and at least one signal path between the control element and at least some of the water nozzles.

19. A system comprising:
a drone associated with a dwelling and having an onboard water tank;
a signal interface on the drone to receive a liftoff signal;
a controller in the drone to fly the drone over the dwelling responsive to the liftoff signal and drop water onto the dwelling from the tank.

20. The system of claim 19, wherein the signal interface is configured to receive the liftoff signal from at least one sensor such that the drone automatically without human intervention goes airborne and drops water onto the dwelling responsive to the liftoff signal.

21. The system of claim 20, wherein the at least one sensor comprises at least one heat sensor and/or at least one smoke sensor and/or at least one camera.

22. The system of claim 21, wherein the liftoff signal comprises output of at least one machine learning (ML) model receiving input from the at least one sensor.

23. The system of claim 19, wherein the signal interface is configured to receive the liftoff signal from at least one human-operated firefighter control system such that the drone goes airborne and drops water onto the dwelling responsive to the liftoff signal.

24. The system of claim 19, wherein the drone comprises an intake system to transfer water from at least one pool or lake nearby the dwelling into the onboard water tank.

25. The system of claim 22, wherein the at least one sensor is onboard the drone.

26. A system comprising:
plural ground-mounted water nozzles located adjacent a single building and being disposed outside of the building;
at least some water nozzles being controllable by respective controllers to spray water onto external surfaces of the building responsive to a control signal, the control signal comprising output from a machine learning (ML) model receiving input from at least one sensor.

27. The system of claim 26, wherein the at least one sensor comprises at least one camera.

28. The system of claim 26, wherein the at least one sensor comprises at least one heat sensor.

29. The system of claim 26, wherein the at least one sensor comprises at least one smoke sensor.

30. An apparatus comprising:
plural electrically-controlled external water jets mounted on the ground near a structure to project water upwardly in an initial projection angle above the horizontal onto the structure, each jet including a respective electrically-controlled valve that is controlled by a processor-implemented controller energized from a diesel generator or battery bank; and
one or more sensors to generate signals to actuate the plural electrically-controlled external water jets.

31. The apparatus of claim 30, wherein the plural electrically-controlled external water jets are configured to be actuated by at least one signal from a fire authority system.

32. The apparatus of claim 30, comprising at least processor system configured to execute at least one machine learning (ML) model to actuate the jets, the ML model configured for outputting a control signal to actuate the jets based at least in part on the signals from the one or more sensors according to training comprising:
inputting to the ML model a training set of camera images of a fire along with corresponding ground truth tags indicating whether a respective one of the training set of camera images indicates jet actuation such that after training the processor system can execute the ML model to receive images and output actuation signals to the jets accordingly.

33. The apparatus of claim 30, comprising at least processor system configured to execute at least one machine learning (ML) model to actuate the jets, the ML model configured for outputting a control signal to actuate the jets based at least in part on the signals from the one or more sensors according to training comprising:
inputting to the ML model a training set of smoke sensor signals along with corresponding ground truth tags indicating whether a respective one of the smoke sensor signals indicates jet actuation such that after training the processor system can execute the ML model to receive signals from at least one smoke sensor to output actuation signals to the jets accordingly.

34. The apparatus of claim 30, comprising at least processor system configured to execute at least one machine learning (ML) model to actuate the jets, the ML model configured for outputting a control signal to actuate the jets based at least in part on the signals from the one or more sensors according to training comprising:
inputting to the ML model a training set of heat sensor signals along with corresponding ground truth tags indicating whether a respective one of the heat sensor signals indicates jet actuation such that after training the processor system can execute the ML model to receive signals from at least one heat sensor to output actuation signals to the jets accordingly.

35. The apparatus of claim 30, comprising at least processor system configured to execute at least one machine learning (ML) model to actuate the jets, the ML model configured for outputting a control signal to actuate the jets based at least in part on the signals from the one or more sensors according to training comprising:
inputting to the ML model a training set of humidity sensor signals along with corresponding ground truth tags indicating whether a respective one of the humidity sensor signals indicates jet actuation such that after training the processor system can execute the ML model to receive signals from at least one humidity sensor to output actuation signals to the jets accordingly.

36. The apparatus of claim 30, comprising at least processor system configured to execute at least one machine learning (ML) model to actuate the jets, the ML model configured for outputting a control signal to actuate the jets based at least in part on the signals from the one or more sensors according to training comprising:
inputting to the ML model a training set of wind sensor sensor signals along with corresponding ground truth tags indicating whether a respective one of the wind sensor signals indicates jet actuation such that after training the processor system can execute the ML model to receive signals from at least one wind sensor to output actuation signals to the jets accordingly.

37. The apparatus of claim 30, comprising at least processor system configured to execute at least one machine learning (ML) model to actuate the jets, the ML model configured for outputting a control signal to actuate the jets based at least in part on the signals from a first sensor type and a second sensor type.
